(19) United States
(12) Patent Application Publication
(10) Pub. No.: US 2025/0368496 A1
(43) Pub. Date: Dec. 4, 2025

(54) FOAMED LIQUID DISPENSING SYSTEM

(71) Applicant: HATFIELDS LONDON LIMITED, Surrey (GB)

(72) Inventor: Timothy Jack Hatfield, London (GB)

(21) Appl. No.: 19/226,580

(22) Filed: Jun. 3, 2025

(30) Foreign Application Priority Data
Jun. 3, 2024 (GB) 2407827.1

(51) Int. Cl. B67D 1/12; A47J 43/12; B67D 1/08

(52) U.S. Cl. CPC B67D 1/1275; A47J 43/121; A47J 43/128; B67D 1/0888; B67D 1/1252

(57) ABSTRACT

A foamed liquid dispensing system includes a container for receiving a liquid to be dispensed connectable to, and removable from, a gas charging unit. The gas charging unit includes a gas compressor, gas pressure sensing means, a control unit and a user interface. The user interface permits a user to input a desired final gas pressure from a minimum value to a maximum value in discrete steps. The control unit instructs the gas compressor to charge the container with gas to the desired final pressure. The gas pressure is continuously monitored and the flow of gas into the container is stopped once the desired final gas pressure has been reached. The user interface displays the gas pressure in the container as the charging cycle proceeds. Once charged with gas and removed from the gas charging unit, the container substantially retains the final desired gas pressure until the liquid is dispensed.

### FIELD AND BACKGROUND OF THE INVENTION

The present invention relates to a system suitable for dispensing foamed liquids such as beverages with a foamed ‘head’. It is useful, for example, in dispensing foamed cold-brew coffee, cold tea, novelty cocktails and other cold beverages which would otherwise be served flat. It is also useful for the dispensing of foamed dairy products such as a cream and milk.

Various approaches to the dispensing of foamed cream and beers are known in the art and have been used extensively. Thus, it is known to pressurise otherwise flat beers with carbon dioxide; a gas having a limited but finite solubility in water, by storing them under pressure in steel kegs which are frequently kept cold to further increase or maintain the degree of carbonation. In addition, other in-line carbonisation of drinks is typically employed in restaurants and bars whereby a concentrated syrup of for example a cola or the like is mixed with water and carbon dioxide immediately upstream of a dispensing tap.

US2013270722 describes a carbonation chamber in which gas and liquid are mixed axially in response to a metering member. Other approaches to ensuring the carbon-dioxide and liquid are intimately mixed have been described in inter alia WO2007112892, DE10160397, DE102004021823, and DE102008012486.

DE202017005461U1 describes an in-line dispensing nozzle system comprising a pipe section and a tapered outlet spout. The spout is characterized in that, between the inlet side of the pipe and the outlet of the spout, there is provided a component for mixing the beverage and a gas. The system can be used to produce nitrogenized coffee or beer.

One problem with systems of the type described above is that they tend to foul easily thereby necessitating frequent cleaning for reasons of hygiene. For many of these systems, this involves a somewhat intricate dismantlement. It also limits their suitability for dispensing perishable liquids.

WO 2019/057983 and GB 2568141 describe a portable beverage dispensing device which mitigates many of the problems associated with prior devices. The device, which is stand-alone, i.e., it does not comprise part of an in-line delivery system of the type used in bars or restaurants, can also be made small enough to be easily stored in a domestic refrigerator. It is also versatile enough to be employed as a stand-alone item in coffee shops and cocktail bars alongside or as an adjunct to the conventional cocktail-shaker. Gas is provided from small, disposable cannisters.

GB 2603750 A represents a development of the device described in WO 2019/057983 and GB 2568141 in that the gas used to foam the liquid is provided via an integral air compressor. This obviates the need for disposable gas cannisters and also permits the use of atmospheric air as the gas used to foam the liquid.

### SUMMARY OF THE INVENTION

Accordingly, the present invention provides a foamed liquid dispensing system comprising a container for receiving a liquid to be dispensed connectable to, and removable from, a gas charging unit; wherein the gas charging unit comprises a gas compressor adapted to charge the container with a gas, gas pressure sensing means, a control unit and a user interface;
wherein the user interface permits a user to input a desired final gas pressure from a minimum value to a maximum value in discrete steps;
wherein in response to the input to the user interface, the control unit instructs the gas compressor to begin a charging cycle to charge the container with a gas to the desired final gas pressure;
wherein the gas pressure sensing means is adapted to continuously monitor the pressure of gas within the container and via the control unit, to instruct the gas compressor to stop the flow of gas into the container once the desired final gas pressure has been reached;
wherein once charged with gas and removed from the gas charging unit, the container substantially retains the final desired gas pressure until the liquid is dispensed; and
wherein the user interface comprises visual display means which displays at least the gas pressure in the container as the charging cycle proceeds.

Preferably the gas is a gas which is substantially insoluble in water at a pressure above atmospheric pressure. Suitable gasses include air, nitrogen, nitrous oxide, carbon dioxide or mixtures thereof.

In a particularly preferred embodiment, the gas is air and is provided to the gas compressor from its surroundings. In this way, no external or additional source of gas is required as the gas compressor simply makes use of the air in the atmosphere surrounding the system. Alternatively, other gasses may be provided to the gas compressor for example from a separate gas supply source such as a compressed gas cylinder or mains supply.

The system may be fully automatic. The user fills the container with the liquid to be dispensed and connects it to the gas charging unit. A charging cycle is initiated where a desired final gas pressure is selected using the user interface and then the system charges the container with gas. The pressure within the container is monitored by the gas pressure sensing means and supply of gas to the container is terminated once the desired final gas pressure is reached. The container can then be removed from the gas charging unit and the liquid dispensed, either immediately or at a later time. This arrangement also guards against the accidental over-pressurisation of the container.

In an embodiment, the visual display means provides a visual indication to the user at the end of the charging cycle to indicate that the desired final gas pressure has been reached. Alternatively, or additionally, the user interface may provide an audible indication to the same effect.

The user interface permits the user to select a desired final gas pressure and in response, the control unit instructs the system to begin a charging cycle to charge the container with gas to the desired final gas pressure. The user interface comprises a visual display means, preferably a digital display, adapted to display at least the gas pressure within the container as the charging cycle proceeds. The visual display means may additionally indicate the ‘on/off’ status of the system. Preferably, the visual display means is situated on the gas charging unit.

Preferably, the digital display is touch-sensitive to enable simple user input. In this embodiment, the touch-sensitive digital display may include an ‘on/off’ button to switch the system on and off. Preferably, touch-sensitive digital display includes a button which when activated, begins the charging cycle.

The user interface permits the user to set a desired final gas pressure value from a minimum value to a maximum value in discrete steps. Any size of discrete step may be used although very fine pressure intervals are not typically required. In a preferred embodiment, the desired final gas pressure may be set in discrete steps of 0.5 bar (50 kPa). A minimum value may be 0.0 bar, preferably 1.0 bar (100 kPa) or more, for example from 1.0 to 4.0 bar (100 to 400 kPa). The maximum value is at least 0.5 bar (50 kPa) above the minimum value, preferably the maximum value is at least 4.5 bar (450 kPa) or more, for example from 5.0 to 10.0 bar (500 to 1000 kPa). Final gas pressure values above 10.0 bar (1000 kPa) are typically not required. In a preferred embodiment, the user interface permits a user to set a final gas pressure of from 3.0 to 10.0 bar (300 to 1000 kPa) in discrete steps of 0.5 bar (50 kPa), more preferably from 4.0 to 9.0 bar (400 to 900 kPa) in discrete steps of 0.5 bar (50 kPa).

Where the user interface comprises a touch-sensitive digital display, preferably buttons are provided to increase and decrease the desired final gas pressure in discrete steps. For example, buttons marked ‘up’ and ‘down’ or ‘+’ and ‘−’. Alternatively, a single button may be provided, repeated activation of which increases the desired final gas pressure in discrete steps until a maximum value, for example 10.0 bar (1000 kPa), is reached and where a further activation of the button cycles the desired final gas pressure back to the minimum value.

Preferably, the user interface permits the user to select one or more pre-set final gas pressure values according to the viscosity of the liquid to be dispensed. These pre-set values are displayed on the visual display means. For lower viscosity liquids such as fruit drinks, beers and coffee, a pre-set final gas pressure of 6.0 bar (600 kPa) has been found to be appropriate. For more viscous liquids such as cream and other dairy products, a pre-set final gas pressure of 8.0 bar (800 kPa) may be used.

The system may be provided with initial (or default) pre-set final gas pressures, for example 6.0 and 8.0 bar (600 and 800 kPa). In a preferred embodiment, these pre-set values may also be chosen or modified by the user.

Where the user interface comprises a touch-sensitive digital display, preferably one or more buttons are provided to select the one or more pre-set final gas pressure values. For example, buttons marked ‘6’ and ‘8’ or ‘HI’ and ‘LOW’. In a preferred embodiment, a single button is provided to select the one or more pre-set final gas pressure values wherein repeated activations of the button cycle between the pre-set values.

Once a charging cycle has been completed, and the charged container removed from the gas charging unit, the system resets to the previous set final gas pressure. The next container can thus be charged to the same pressure or to a different pressure, either by step-wise altering the set final gas pressure or by selecting a different pre-set final gas pressure value.

Preferably, the gas pressure sensing means comprises a micro pressure sensor. Other types of pressure sensor or transducer known in the art may alternatively be used. Preferably the pressure sensor is located close to the junction between the container and the gas charging unit. This permits a more accurate measurement of the true gas pressure inside the container.

Preferably the control unit comprises a suitably configured micro-processor for example, incorporated into a printed circuit board. The gas pressure sensing means, for example a micro pressure sensor, may conveniently be incorporated into or mounted on the printed circuit board. Conveniently, the user interface, including for example a touch-sensitive digital display, may be incorporated into, or attached to, the control unit. In a preferred embodiment, the control unit, the user interface and the gas sensing means are all part of a single module.

The gas charging unit is suitably comprised of a plastic or metal housing in which its various components are contained. Preferably, the gas charging unit comprises of a metal housing, such as aluminium or stainless steel, with stainless steel being particularly preferred. It preferably includes a flat plinth designed to lie horizontal when the gas charging unit is located on a flat surface such as worktop or kitchen counter. The unit is provided with coupling means to permit connection to the container. The gas compressor is located in the housing and is typically electrically operated. In an embodiment, it is attached to a manifold including a multi-port valve, typically and electrically operated solenoid valve or similar. This valve may comprise two, or preferably three, attachment ports. One port is attached to the coupling means and another to an exhaust pathway able to relieve pressure in the gas charging unit once pressurisation of the container is complete.

The container is preferably a container as described in WO 2019/057983 and GB 2568141 where connection to the gas charging device is made via the means (modified as necessary) which are used to connect the disposable gas cannister. In a preferred embodiment, the means to connect the container to the gas charging device also permit the connection of the disposable gas cannisters described in WO 2019/057983 and GB 2568141 so providing the user with a choice of gas source.

In one embodiment, the container is an elongate flask with a threaded end which may be attached to a lid on which the means to connect to the gas charging unit, and/or a dispensing unit and/or a trigger may be mounted. Typically, it will be made of metal, an engineering plastic or other robust material able to withstand an internal overpressure. Preferably, the container is made of metal, preferably stainless steel. In another embodiment, the lid may further include a pressure-release valve to ensure the device is not over-pressurised.

In one embodiment, the container may be wholly or partially transparent enabling the user to determine the level of liquid within. If desired, the container may be double-walled akin to a vacuum flask thereby enabling the liquid contents to be maintained warmer or colder than ambient temperature.

The container preferably includes a foam-dispensing nozzle assembly including a dispensing means for creating a laminar flow of a foamed mixture and one or more gas-liquid mixing elements located upstream thereof and a trigger mechanism for actuating discharge of the foam from the foam-dispensing nozzle assembly. In one embodiment, the foam-dispensing nozzle assembly is hollow and attached to the lid by means of a screw-thread. The dispensing unit enables the dispensing of the foamed liquid from the nozzle assembly to a suitable external vessel, typically a glass or cup. It generally comprises a suitable outlet, or nozzle, by which the foamed liquid can exit the nozzle assembly. Suitably, the nozzle assembly will comprise a housing tapered in the direction of its outlet. The means for creating the laminar flow will suitably comprise a perforated element enabling multiple streams of the gas/liquid mixture to be dispensed as a foam under conditions of laminar flow. In another, it will also include a flow-directing insert. In one example, this perforated element will be located immediately upstream of the nozzle by means of a seating which enables it to be easily removed for cleaning. In one embodiment, this element may be a perforated disc of metal, plastic or ceramic with associated perforations large enough to facilitate laminar flow but small enough to prevent particulate matter of significant size to exit the device.

Turning to the gas-liquid mixing element(s), in one embodiment these may comprise one or more Venturi mixers where acceleration of liquid flow through a hollow tubing (e.g. by means of a variable bore size) can be used to induce gas introduction and mixing by means of suction. In another, the elements may comprise Coanda mixers. In yet another example, these elements may comprise one or more jet-mixing elements akin to an aerator of the type used in household taps to aerate or mix hot and cold water streams. In one embodiment, such element(s) comprise hollow perforated plastic inserts which are arranged in series along the axis of liquid flow and located in the body of the assembly thereby making them easily removable for cleaning or replacement purposes. In another embodiment, the gas-liquid mixer(s) and means for creating the laminar flow are located in separate sub-components of the foam-dispensing nozzle assembly which are adapted to connect one another; e.g. by means of a screw thread or snap-fit.

In one embodiment, the container may include a particle filter to filter out coffee grounds or similar sediments found in other beverages.

Finally, the trigger mechanism is one which conveniently is hand-operated, for example by squeezing, and operable to control ingress of the gas and/or liquid into the dispensing unit and/or egress of the gas-liquid mixture from the foam-dispensing assembly.

The system of the present invention can be used for dispensing any of the beverages described in the preamble above. This list is provided for exemplification purposes only and therefore not be regarded as exhaustive. For example, the device can also be used to rejuvenate flat beer and the like. In one embodiment, the device is especially useful for dispensing cold-brewed coffee; preferably where the average particle size of the fines within the coffee brew are less than a hundred microns. In another embodiment, it is also useful in producing foamed tea, coffee or other cold beverages which have been augmented with various flavourings; for example with spices, herbs or the like which have been introduced into the container along with the beverage or one of its components before the device is used. In yet another embodiment, it has been found that foamed dairy products such as foamed cream or milk can easily be produced.

### BRIEF DESCRIPTION OF DRAWINGS

The system of the present invention is illustrated by the attached Figures where:

FIG. 1 shows a perspective view of a foamed liquid dispensing system according to the present invention;

FIG. 2 shows a cross-sectional side elevation of a foamed liquid dispensing system according to the present invention; and

FIG. 3 shows a representation of an example of a user interface suitable for use in the system of the present invention incorporating a digital display means.

### DETAILED DESCRIPTION OF THE INVENTION

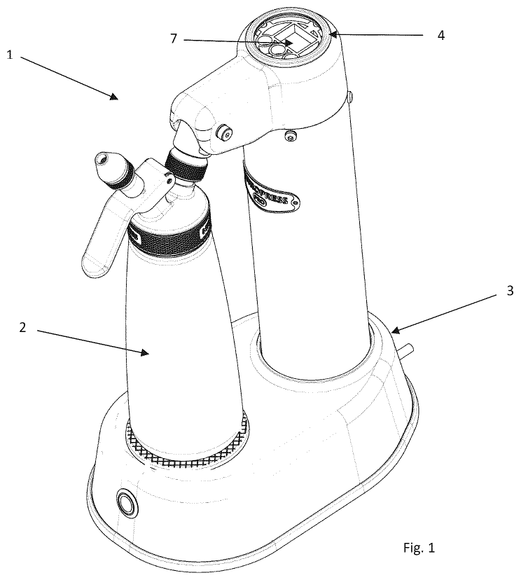

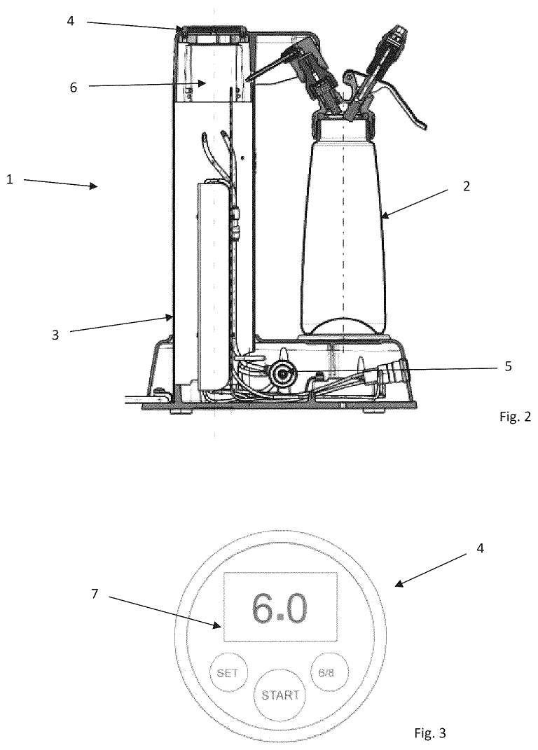

As shown in FIG. 1 and FIG. 2, a foamed liquid dispensing system 1 comprises a container 2 connectable to and removable from a gas charging unit 3. The liquid to be foamed, for example coffee, is loaded into the container. The gas charging unit 3 incorporates a gas compressor 5 which is able to charge the container with pressurized gas. In the example illustrated, the gas provided to the container is air. The unit 3 also includes a gas micro pressure sensor (not shown) incorporated into a control unit 6, and a user interface 4. The micro pressure sensor is situated close to the junction between the container 2 and the gas charging unit 3.

FIG. 3 shows an example of a user interface 4 in more detail. Here, a touch-sensitive digital display 7 allows a user to set a desired final gas pressure by repeated activation of the button marked ‘SET’ each of which increases the pressure value by 0.5 bar (50 kPa). The desired final pressure is displayed on the screen. The example shown also permits the selection of one of two pre-set final pressure values by sequential activation of the ‘6/8’ button shown which sets the desired final gas pressure of either 6.0 or 8.0 bar (600 or 800 kPa). Activation of the button marked ‘START’ begins a charging cycle whereby the control unit 6 instructs the gas compressor 5 to charge the container with air. It will be understood that FIG. 3 is merely illustrative, and that other text, markings or symbols may be alternatively used.

The pressure sensor continuously monitors the pressure of gas within the container and so once a charging cycle has been initiated, the pressure in the container rises until the pressure sensor senses that the desired final pressure has been reached. The control unit then instructs the gas compressor to stop the flow of gas into the container.

Once the container has been pressurized with air to the desired pressure, the container 2 may be removed from the gas charging unit 3 and its contents dispensed.

1. A foamed liquid dispensing system comprising:
a container for receiving a liquid to be dispensed connectable to, and removable from, a gas charging unit; wherein the gas charging unit comprises a gas compressor adapted to charge the container with a gas, gas pressure sensing means, a control unit and a user interface;
wherein the user interface permits a user to input a desired final gas pressure from a minimum value to a maximum value in discrete steps;
wherein in response to the input to the user interface, the control unit instructs the gas compressor to begin a charging cycle to charge the container with a gas to the desired final gas pressure;
wherein the gas pressure sensing means is adapted to continuously monitor the pressure of gas within the container and via the control unit, to instruct the gas compressor to stop a flow of gas into the container once the desired final gas pressure has been reached;
wherein once charged with gas and removed from the gas charging unit, the container substantially retains the final desired gas pressure until the liquid is dispensed; and
wherein the user interface comprises visual display means which displays at least the gas pressure in the container as the charging cycle proceeds.

2. The system according to claim 1 wherein the visual display means comprises a digital display.

3. The system according to claim 1 wherein the user interface allows a user to set a final gas pressure of from 3.0 to 10.0 bar (300 to 1000 kPa) in discrete steps of 0.5 bar (50 kPa).

4. The system according to claim 1 wherein the user interface permits the user to select one or more pre-set final pressure values according to a viscosity of the liquid to be dispensed, the pre-set final pressure values being displayed on the visual display means.

5. The system according to claim 1 wherein the visual display comprises a touch-sensitive digital display having one or more buttons to select one or more pre-set final pressure values.

6. The system according to claim 1 wherein the visual display comprises a touch-sensitive digital display having one or more buttons to increase and decrease the desired final gas pressure in discrete steps.

7. The system according to claim 1 wherein the container comprises a foam-dispensing nozzle assembly including a dispensing means for creating a laminar flow of a foamed mixture and one or more gas-liquid mixing elements located upstream thereof and a trigger for actuating discharge of foam from the foam-dispensing nozzle assembly.

8. The system according to claim 7 wherein the one or more gas-liquid mixing elements comprise at least one of a Venturi mixer, a jet mixer and a Coanda mixer.

9. The system according to claim 1 wherein the gas is a gas which is substantially insoluble in water at a pressure above atmospheric pressure.

10. The system according to claim 1, wherein the gas is selected from the group consisting of air, nitrogen, nitrous oxide, carbon dioxide, and mixtures thereof.

11. The system according to claim 1 wherein the gas is air provided to the gas compressor from its surroundings.

12. The system according to claim 1 wherein the liquid is a beverage or a dairy product.

13. The system according to claim 1 wherein the liquid is coffee, tea, or beer.

14. The system according to claim 1 wherein the liquid is milk or cream.
